(19) United States
(12) Patent Application Publication
(10) Pub. No.: US 2026/0311353 A1
(43) Pub. Date: Oct. 8, 2026

(54) MULTI-LAYER REPRESENTATIONS FOR ARTISTICALLY CONTROLLABLE STEREO CONVERSION

(71) Applicant: DISNEY ENTERPRISES, INC., Burbank, CA (US)

(72) Inventors: Lukas Francesco MEHL, Stuttgart (DE); Tunc Ozan AYDIN, Zürich (CH); Emma L. WEBB, Los Angeles, CA (US); Christopher Richard SCHROERS, Uster (CH); Jacqueline P. HUTCHINSON, Temecula, CA (US); Raphael Francois ORTIZ, Dübendorf (CH)

(21) Appl. No.: 19/173,633

(22) Filed: Apr. 8, 2025

(51) Int. Cl. G06T 7/50; G06T 3/18; G06T 5/50; G06T 5/77

(52) U.S. Cl. CPC G06T 7/50; G06T 3/18; G06T 5/50; G06T 5/77; G06T 2207/20221

(57) ABSTRACT

The present invention sets forth a technique for performing stereo conversion. This technique includes generating, using a first set of machine learning models, a predicted depth map for an input image based on one or more depth values associated with pixels within the input image, determining one or more uncertainty regions associated with the depth map, wherein each uncertainty region identifies a different area of the input image having one or more pixels that can be in multiple depth layers on the input image, processing, using a second set of machine learning models, the depth map and the one or more uncertainty regions to determine, for each pixel in one of the one or more uncertainty regions, a foreground context and a background context for that pixel based on the depth map, and generating an output image based on the foreground context and background context.

### BACKGROUND

### Field of the Various Embodiments

Embodiments of the present disclosure relate generally to machine learning and computer vision and, more specifically, to techniques for performing artistically controllable stereo conversion using artificial intelligence.

### Description of the Related Art

Stereo conversion refers to the generation of stereoscopic video content from a traditional monocular (non-stereo) video sequence. For example, live-action feature films are often not filmed in stereo, but it may be desirable for a movie studio to produce a stereo version of a film for distribution alongside a non-stereo version of the film. This is achieved through stereo conversion implemented as a post-production process. Further, movie studios often possess large amounts of legacy content, and stereo conversion allows the studio to make this legacy content available to audiences in stereo.

Stereo conversion during the post-production process is a costly and often manual process. There are several approaches that offer automated or partially automated stereo conversion techniques. One subset of approaches operates with a single depth value per pixel and, as a result, struggle in several situations. For example, intricate object boundaries, such as hair where multiple colors may be mixed, cannot be represented with a single depth. In another example, reflections and partially transparent objects also require multiple depth layers. Finally, volumetric phenomena, such as fire or smoke, are not modelled by these approaches. As a result, a large number of scenes cannot be properly processed by approaches that operate with a single depth value per pixel.

Another subset of approaches tackles dynamic scenes and are optimized with a volumetric image formation model. As a result, these approaches are equipped to solve the aforementioned challenges. However, because these approaches are optimization based, they are more costly and difficult to run at high resolutions and to obtain production quality result. Another drawback is that these approaches do not leverage existing knowledge from pretrained models to the fullest extent and thus can be computationally wasteful.

As the foregoing illustrates, what is needed in the art are more effective techniques for stereo conversion of video frames or sequences.

### SUMMARY

One embodiment of the present invention sets forth a technique for performing stereo conversion. The technique includes generating, using a first set of machine learning models, a predicted depth map for an input image based on one or more depth values associated with pixels within the input image, determining one or more uncertainty regions associated with the depth map, wherein each uncertainty region identifies a different area of the input image having one or more pixels that can be in multiple depth layers on the input image, processing, using a second set of machine learning models, the depth map and the one or more uncertainty regions to determine, for each pixel in one of the one or more uncertainty regions, a foreground context and a background context for that pixel based on the depth map, and generating an output image based on the foreground context and background context for each pixel in the one or more uncertainty regions, wherein the output image forms a stereo pair with the input image.

One technical advantage of the disclosed technique relative to the prior art is that pre-trained models or prior knowledge from those models are efficiently leveraged estimate multi-layer depth representations from a single input image in high quality. Furthermore, the disclosed approach enables high quality inpainting in multi-layer representations while also considering temporal aspects. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments.

FIG. 2 is a more detailed illustration of the stereo conversion engine of FIG. 1, according to various embodiments.

FIG. 3 is a more detailed illustration of the training engine of FIG. 1, according to various embodiments.

FIG. 4 is a flow diagram of method steps for performing stereo conversion on a single input image, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

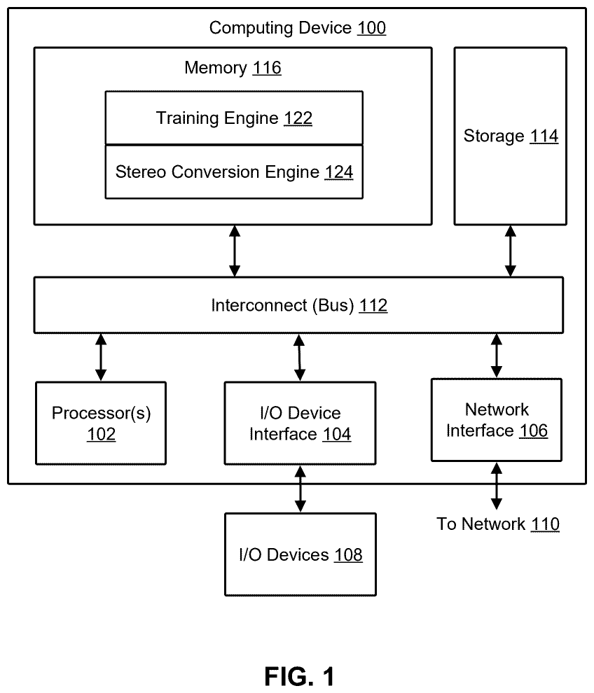

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and a stereo conversion engine 124 that reside in a memory 116.

It is noted that the computing device described herein is illustrative and that any other technically feasible configurations fall within the scope of the present disclosure. For example, multiple instances of training engine 122 and stereo conversion engine 124 could execute on a set of nodes in a distributed and/or cloud computing system to implement the functionality of computing device 100. In another example, training engine 122 and/or stereo conversion engine 124 could execute on various sets of hardware, types of devices, or environments to adapt training engine 122 and/or stereo conversion engine 124 to different use cases or applications. In a third example, training engine 122 and stereo conversion engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid state storage devices. Training engine 122 and stereo conversion engine 124 may be stored in storage 114 and loaded into memory 116 when executed.

Memory 116 includes a random access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 and stereo conversion engine 124.

In some embodiments, training engine 122 trains one or more machine learning models to perform stereo conversion. In stereo conversion, the contents of an image or video frame are modified to generate a corresponding output image forming a stereo pair with the input image or video frame. Stereo conversion engine 124 executes machine learning model(s) to generate a predicted output image or frame from a provided image or video frame. “Frame” and “video frame” are used interchangeably throughout this description.

More specifically, training engine 122 and stereo conversion engine 124 are configured to train and execute one or more machine learning models that perform stereo conversion on an input image or video frame. In operation, the stereo conversion engine 124 generates a multi-layer representation of an input image at high quality while potentially considering temporal information. The stereo conversion engine 124 then fills in missing regions or dis-occlusions in the multi-layer representation, again maintaining high quality and potentially considering temporal information. In some embodiments, as a final step, the stereo conversion engine 124 also cleans up compositing and warping artifacts in the image.

### Stereo Conversion

The digital image formation process involves projecting the 3D geometry of a scene onto a 2D camera plane. An inevitable consequence of this inherent dimensionality reduction is that fragments from multiple objects at different distances from the camera may end up being projected onto the same image pixel. Typically, in the majority of image regions of natural images, a fully opaque object fragment closest to the camera occludes any other object fragments projected onto the same pixel. The pixels in such regions then assume the color of that occluding object closest to the camera. On the other hand, an image may also have regions in which the object fragments at different depths may either be partially transparent (e.g. a plastic bag) or may be very small in size to the point that they don't cover the full surface area of an image pixel (e.g. a hair fiber). The pixels of such image regions consequently do not just entail the pure color of the object fragment closest camera, but a mixture (e.g., a convex combination) of colors of multiple object fragments modulated by their individual opacities.

Formally, for a given pixel we can express the relation between the color of the pixel in question (c∈R³) and the colors (cₗ) and opacities (αₗ) of corresponding object fragments at different depths (indexed with l∈[1, L]) through the iterative application of the over compositing operator as follows:

$${c}_{l - 1} = \frac{{c}_{l - 1} {α}_{l - 1} + {c}_{l} {α}_{l} ( 1 - {α}_{l - 1} )}{{α}_{l - 1} + {α}_{l} ( 1 - {α}_{l - 1} )} for l ∈ [ L , L - 1 , … , 1 ] . \qquad ( 1 )$$

Without loss of generality, consider the case where L=2 and let us accordingly refer to l=1 as the foreground and l=2 as the background. Moreover, let the opacity of the foreground be a and the background be fully opaque. Applying the aforementioned assumptions to Equation 1, we arrive at the familiar alpha compositing formula for foreground and background layers:

$$c = {c}_{fg} α + {c}_{bg} ( 1 - α ) , \qquad ( 2 )$$

where c is the observed color of the pixel in question. Solving the inverse problem corresponding to Equation 2 is useful for a number of practical applications such as compositing. In the inverse setting, the goal is to predict per-pixel c_{fg}, c_{bg}, and α values given the observed pixel color c, such that the identity in Equation 2 holds. This problem is referred as image matting.

The following discussion provides one or more embodiments for processing RGB (red, green, blue) image frames for stereo conversion using depth-guided image matting. In operation, an image frame is converted into a multi-layer depth representation, which corresponds to a scene decomposition. More specifically, a multi-layer depth representation supports multiple values for each pixel, where a single value contains information about color, depth, and alpha. The depth representation combined with an uncertainty region representation corresponding to the depth representation are processed by one or more machine learning models to output a pair of color and depth images, as well as an alpha image. In this manner, the depth-guided image matting approach can determine, based on the depth map, what the foreground and background context should be depending on which pixel in the uncertainty region currently being decomposing.

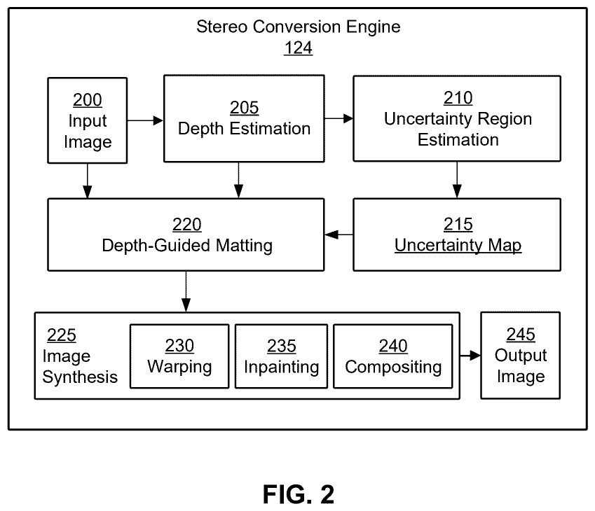

FIG. 2 is a more detailed illustration of stereo conversion engine 124 of FIG. 1, according to some embodiments. In these embodiments, stereo conversion engine 124 modifies an input color image 200 (e.g., a still image or a single frame from a video sequence) and generates predicted output image 245. Input image 200 and the generated predicted output image 245 form a stereo pair of images. This stereo pair, when viewed together, depicts a scene that presents the illusion of relative depth between the various objects in the scene and between the objects and the background. In various embodiments, the input image may be a left image for which a corresponding predicted right image is to be generated, or a right image for which a corresponding predicted left image is to be generated. In various other embodiments, the input may be a center image for which both left and right output images are to be generated (for example, sequentially).

Stereo conversion engine 124 includes depth estimation 205. Depth estimation 205 generates a depth map associated with the input image with more than two depth layers—where a single pixel can be both in the foreground and in the background. The depth map specifies the depth d of objects and backgrounds in the input image. The depth d represents the distance between the camera and an object or background shown in the input image. In various embodiments, depth estimation 205 predicts the inverse depth (1/d), because input images often depict background objects, such as the sun or sky, at great or near-infinite distances. The resulting inverse depth estimations are recorded on a per-pixel basis.

In various embodiments, one or more machine learning models may be used to generate the depth map. For example, a convolutional neural network (CNN) or a transformer may be trained to learn depth priors from large-scale datasets using supervised, self-supervised, or unsupervised training paradigms. These models leverage geometric constraints, photometric consistency, and learned feature representations to approximate the depth function and generate a depth map from an input image.

Uncertainty region estimation 210 generates an uncertainty map 215 based on the depth map. The uncertainty map 215 identifies one or more uncertainty regions where the classification between foregrounds and backgrounds in the image are ambiguous. In some embodiments, the uncertainty map 215 is a binary map. Uncertainty regions typically occur along object boundaries, where a pixel may contain a mixture of both foreground and background colors and, thus, the alpha values need to be estimated. In various embodiments where the depth map is multi-layered, the uncertainty regions could be programmatically computed based on adaptively extruding relevant depth edges. In other embodiments, a neural network can be trained to predict the uncertainty regions given the input image and the depth map.

Depth-guided matting 220 processes the input color image 200, the depth map generated by depth estimation 205 and the uncertainty map 215 to determine, based on the depth map, the foreground and background context depending on which pixel in the uncertainty region currently being decomposed. The output of depth-guided matting 220 includes a pair of color and depth images, as well as an alpha image.

In various embodiments, depth-guided matting 220 is implemented as a neural network, such as UNet. In one embodiment, depth-guided matting uses a UNet-like architecture, which consist of 5 encoder and decoder scales, comprising convolutional blocks with 32, 64, 128, 256, 512 channels. Different from the standard UNet model, the latent variables at the bottleneck of the model are processed by a cascade of transformer blocks (8 blocks with κ heads each with embedding dimension 2048).

While the above workflow allows to deal with a large number of scenes containing an arbitrary number of depth layers, it still follows the assumption that every output pixel can be explained by combining two samples. In most embodiments, this assumption holds for a vast majority of scenes, yet there may be cases with more complex interactions and volumetric effects. For example, there may be some cases where complex interactions and volumetric effects would require to unmix a pixel into more samples. To account for these cases, in some embodiments, the input to depth-guided matting 220 is the depth map and the color image and, instead of providing the uncertainty region in a binary way, the uncertainty regions are specified as an integer value at each uncertain pixel location describing into how many components that pixel needs to be unmixed. Depth-guided matting 220 then outputs that many alpha, color, and depth values at each pixel location, which can then be combined to obtain the observed pixel color according to Equation 1.

Once the color, depth, and alpha values per pixel are determined, image synthesis 225 generates an output image 245 corresponding to a stereo image pair of input image 200. Image synthesis 225 includes warping 230, inpainting 235, and compositing 240.

Let's first consider novel view synthesis for scenes that are decomposed into two distinct globally separate layers, the foreground (FG) and the background (BG). From the decomposition step, we assume the following to be given: the foreground and background image data I_{FG} and I_{BG}, the corresponding alpha maps α_{FG} and α_{BG} with α_{FG}=1−α_{BG} as well as the foreground and background disparity maps d_{FG} and d_{BG}. Image synthesis 225 occurs in three steps: background inpainting, separate per-layer stereo conversion and merging.

First, inpainting 235 is performed, in which areas that become disoccluded by moving the foreground separately from the background are filled. In various embodiments, inpainting 235 employs an arbitrary inpainting algorithm, which takes an initial image and the binary mask of the inpainting area as input. In various embodiments, the background image I_{BG} is taken as the initial image and there are several options on how to choose the binary inpainting area. If the matting process was successful, then semitransparent areas with α_{BG}∈(0, 1) are already correctly filled and inpainting has to be only performed in locations where α_{BG}=0. However, in practice it can be that artifacts of the foreground are still visible in the background, e.g. hair. In this case, inpainting is performed on a wider mask, which can be obtained by thresholding α_{BG} or by taking the outer-most trimap area, i.e. T>0.

Second, after filling in the background layer, the stereo conversion process is applied to both the background and foreground layers independently using foreground and background disparity maps. For the foreground layer, the corresponding alpha map is converted as discussed above in the context of the background layer. For the conversion itself, any stereo conversion method can be used, such as that described in “ARTISTICALLY CONTROLLABLE STEREO CONVERSION,” application Ser. No. 18/473,947, which is incorporated herein by reference. Finally, the inpainted background and foreground layers are merged via compositing 240. In various embodiments, over compositing is used, where the foreground layer is pre-multiplied with the warped foreground alpha mask.

Next, let's consider a stereo conversion process for scenes that are decomposed into a multi-layer depth format, as described above. Note that also the simple foreground-background case can be converted in such a format, making image synthesis approach described below generalizable to all cases considered here.

In one embodiment, warping 230 is performed first in a stereo conversion process for scenes that are decomposed into a multi-layer depth format. In various embodiments, warping 230 includes warping the feature space representation of an input image (e.g., the background image or the foreground image) according to the per-pixel displacement vectors in a disparity map. Specifically, each pixel in the feature space representation of the input image is shifted by a displacement vector proportional to the disparity value estimated for that pixel in predicted disparity map. The warped feature space representation of the input image includes disoccluded areas, where previously hidden areas of the background are exposed by the displacement of objects in the scene. These disoccluded areas are left unfilled by the warping process and are filled in during a later inpainting step. The warped representation also includes occluded areas where multiple pixels from the input image are displaced onto the same location in the feature space representation. Depth-aware splatting addresses these occluded areas with a differentiable warping strategy, which includes weights to determine the ordering of multiple pixels warped to the same location. This ordering determines which of multiple pixels displaced to the same location in feature space (i.e., splatted) should remain visible. The weights are generated from the per-pixel disparity values in predicted disparity map. Foreground objects will have a smaller estimated depth value compared to background objects, and therefore the foreground objects' pixels were assigned larger disparity values by disparity estimation. Thus, the disparity values provide a direct indication of which pixels are in the foreground and should remain visible and which pixels are in the background and should remain hidden.

After warping, background-aware inpainting 235, and compositing 240, image synthesis 225 converts the multi-resolution feature space representation into the final predicted output image 245. In various embodiments, image synthesis 225 utilizes a GridNet convolutional neural network architecture comprising three rows and six columns to perform the conversion, with bilinear upsampling replacing transposed convolutions in the network.

In another embodiment, inpainting 235 is performed first in a stereo conversion process for scenes that are decomposed into a multi-layer depth format. Given the decomposed scene as deep data, the output pixels that should be inpainted are determined. To this end, the stereo conversion result for a maximum disparity range should be chosen in advance; e.g. −40 px to +40 px and the resulting unfilled areas after warping are stored. With these pixel locations, backward warping is performed to obtain the corresponding locations in the source frame. A neural network is then used to perform inpainting in deep pixel space at these locations.

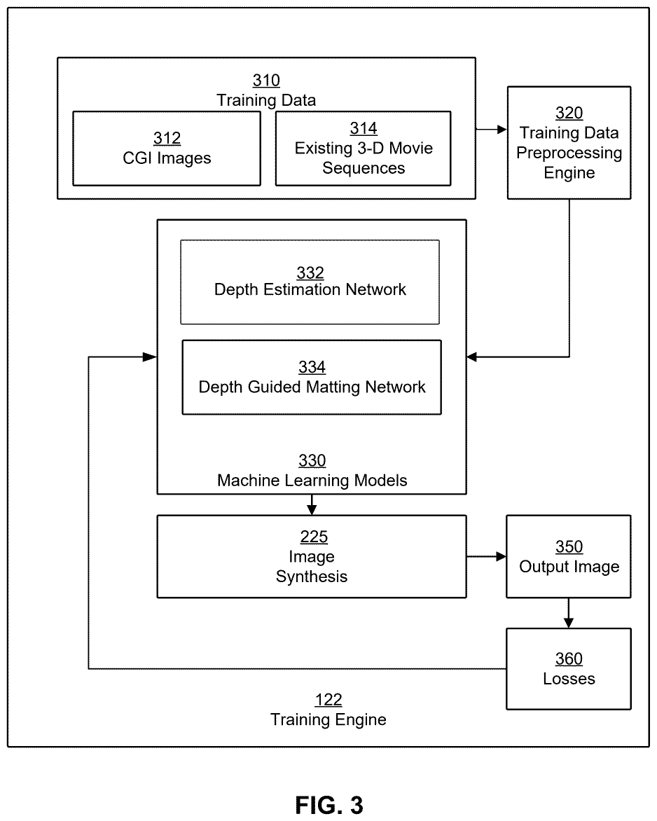

FIG. 3 is a more detailed illustration of training engine 122 of FIG. 1, according to some embodiments. Training engine 122 trains a machine learning model 330 that modifies an input image or a video frame to produce a predicted output image 350. The predicted output image 350 and the corresponding input image or video frame form a stereo pair of images. This stereo pair of images, when viewed together, depict a scene that presents the illusion of relative depth between the various objects in the scene and between the objects and the background. As shown, training engine 122 includes a machine learning model 330, training data 310, and training data preprocessing engine 320.

Training data 310 may include Computer Generated Imagery (CGI) images 312. A CGI image is a two-dimensional image or video frame depicting objects and/or backgrounds within a virtual three-dimensional space. In various embodiments, each of the CGI images 312 further includes explicit location, size, and shape data describing the objects and/or backgrounds depicted in the CGI image.

Training data 310 may also include existing three-dimensional (3D) movie sequences 314. 3D movie sequences 314 include multiple frames, where each frame includes a stereo pair of images. As described above, this stereo pair of images, when viewed together, depict a scene that presents the illusion of relative depth between the various objects in the scene and between the objects and the background.

The training data preprocessing engine 320 processes training data 310 and then provides the processed training data to machine learning model 330. For example, in various embodiments, the training data preprocessing engine 320 processes the CGI image 312 and associated explicit location, size, and shape data to calculate the relative depths between the various objects and/or backgrounds depicted in the CGI image 312. Based on these calculated relative depths, the training data preprocessing engine 320 calculates ground truth disparity values for the objects depicted in the scene. In various embodiments, disparity refers to the offset, expressed in pixels, between an object's depicted location in one image (e.g., the left image) of a stereo pair and that same object's depicted location in the other image of the stereo pair (e.g., the right image). This offset in an object's location between the two images in a stereo pair provides the desired illusion of depth when a viewer views the stereo pair together.

In various embodiments, the training data 310 comprises existing 3D movie sequences 314. Each of these existing 3D movie sequences 314 includes a sequence of frames, with each frame represented as a stereo pair of images. In various embodiments, not all stereo pairs of images contained in an existing 3D movie sequence 314 are useful as training data for a stereo conversion machine learning model. In such embodiments, training data preprocessing engine 320 removes unwanted frames or sequences of frames from the 3D movie sequence 314. For example, training data preprocessing engine 320 removes frames from an existing 3D movie sequence 314 that contain no or little useful information, such as black or blank frames. Training data preprocessing engine 320 may also remove sequences of frames from an existing 3D movie sequence 314 where no 3D effect has been applied, such as studio intros or producer credits. In frames without any applied 3D effects, both images of the stereo image pair will be identical and may yield no useful training information for machine learning model 330.

In various embodiments, the foreground data in training data 310 comprises a mixture of high-resolution images of various objects, along with high-quality alpha mattes, images generated through rendering human faces with hair (with alpha channels obtained through blender), and images of various objects whose alpha mattes are estimated through color triangulation.

Training data preprocessing engine 320 may further perform depth estimation of all background and foreground training images using a depth estimation machine learning model, e.g., the MIDAS model. For depth estimation, the foreground images are composited with a random background image. A Gaussian blur is applied to the background image before compositing in order to minimize the effect of the background objects on depth estimation. Training data preprocessing engine 320 also pre-processes all images to ensure that they are in proper color spaces, have the expected shape, and do not contain any invalid values, such as NaNs or Infs. In various embodiments, the pre-processed color and alpha images, along with their depth predictions are stored in exr format.

In some embodiments where training engine 122 trains machine learning model 330 to perform stereo conversion on an image, training data preprocessing engine 320 may select a representative frame from a shot after filtering out unsuitable frames as described above. In other embodiments where training engine 122 trains machine learning model 330 to perform stereo conversion on a sequence of images, training data preprocessing engine 320 may select a representative sequence of frames from a particular shot after further filtering out frame sequences in the shot which show little or no object motion in the shot (i.e. static shots). For example, training data preprocessing engine 320 may impose a minimum object motion threshold between adjacent frames. In one, non-limiting example, the minimum object motion threshold may be eight pixels between adjacent frames.

The machine learning model 330 includes a depth estimation network 332. The depth estimation network 332 takes preprocessed training data as input, either a CGI image or one frame of a representative sequence of frames from an existing 3D movie sequence. In various embodiments where the input image to depth estimation network 332 is one frame of a representative sequence of frames from an existing 3D movie sequence, the depth estimation network 332 predicts a depth map indicating the depth d for each object in the image. The depth d represents the distance between the camera and the object or background shown in the image.

As shown in FIG. 3, machine learning models 330 also includes a depth guided matting network 334. In various embodiments, the depth guided matting network 334 is implemented as a neural network, such as UNet. In one embodiment, depth-guided matting uses a UNet-like architecture, which consist of 5 encoder and decoder scales, comprising convolutional blocks with 32, 64, 128, 256, 512 channels. Different from the standard UNet model, the latent variables at the bottleneck of the model are processed by a cascade of transformer blocks (8 blocks with 8 heads each with embedding dimension 2048).

During training, pseduo-depth maps are generated by combining the pre-computed foreground and background depthmaps. The foreground and background depth maps are combined in a randomized fashion, where the background depth values are mapped to a range∈[0, 0.2+ε], and the corresponding foreground depth values are mapped to a range∈[0.2+ε, 1.0], where ε∈[0, 0.6] is a random number. The uncertainty regions, during training, are generated by randomly dilating the parts of the ground truth alpha matte that entail values∈(0, 1).

In various embodiments, the training is performed for 1 million iterations with a batch size of 8. In some embodiments, an optimizer starting with a linear warm-up of 1000 iterations is used followed by an exponential decay during the rest of the iterations. The training engine 122 evaluates separate L1 losses 360 applied to the Fourier spectra of predicted and ground-truth foreground color, background color, foreground depth, background depth, and alpha images. There is an additional compositing loss between the input color image and a composited image generated from the predicted foreground and background.

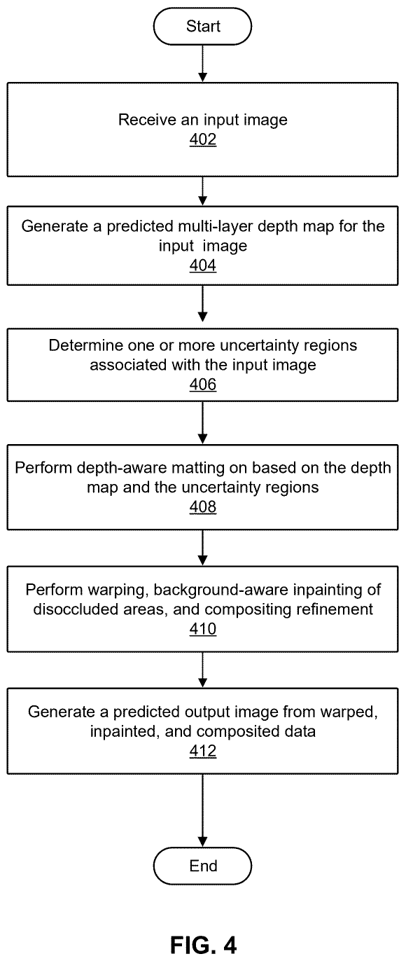

FIG. 4 is a flow diagram of method steps for performing stereo conversion on a single input image, according to various embodiments. Although the method steps are described in conjunction with the systems of FIGS. 1-3, persons skilled in the art will understand that any system configured to perform the method steps in any order falls within the scope of the present disclosure.

As shown, in operation 402, stereo conversion engine 124 receives an input image. In various embodiments, the input image may be a still color image or a single frame from a video sequence.

In operation 404, stereo conversion engine 124 generates a predicted depth map for the input image. Stereo conversion engine 124 executes a first trained neural network to perform depth prediction for various objects and backgrounds depicted in the representation. The depth map specifies the depth d of objects and backgrounds in the input image. The depth d represents the distance between the camera and an object or background shown in the input image. In various embodiments, depth estimation 205 predicts the inverse depth (1/d), because input images often depict background objects, such as the sun or sky, at great or near-infinite distances. The resulting inverse depth estimations are recorded on a per-pixel basis.

In operation 406, stereo conversion engine 124 determines one or more uncertainty regions associated with the depth map. An uncertainty region is an area of the image where classification between foregrounds and backgrounds are ambiguous. In some embodiments, the uncertainty regions are defined in a binary map. Uncertainty regions typically occur along object boundaries, where a pixel may contain a mixture of both foreground and background colors and, thus, the alpha values need to be estimated. In various embodiments where the depth map is multi-layered, the uncertainty regions could programmatically be computed based on adaptively extruding relevant depth edges. In other embodiments, a neural network can be trained to predict the uncertainty regions given the input image and the depth map.

In operation 408, stereo conversion engine 124 performs depth-guided matting based on the input color image, the depth map, and the uncertainty regions. The stereo conversion engine 124 determines, based on the depth map, the foreground and background context depending on which pixel in the uncertainty region currently being decomposed. The output of depth-guided matting includes a pair of color and depth images for the foreground and the background, as well as an alpha image.

In operation 410, stereo conversion engine 124 performs warping, background-aware inpainting of disoccluded areas, and compositing on the outputs generated from the depth-guided matting. Disoccluded areas are regions in the input image where background objects were previously occluded by one or more foreground objects but are made visible by the warping process. Stereo conversion engine 124 intelligently fills in (inpaints) these regions solely using information from the image background. Stereo conversion engine 124 further performs compositing refinement of pixels to remove sharp edges and aliasing artifacts.

In operation 412, stereo conversion engine 124 converts the warped and inpainted data into a predicted output image. The predicted output image, when viewed together with the input image, form a stereo pair that presents the illusion of differing relative depths for the various objects depicted in the image.

CLAUSE 1. In one or more embodiments, a computer-implemented method performs stereo conversion, the computer-implemented method comprising: generating, using a first set of machine learning models, a depth map for an input image based on one or more depth values associated with pixels within the input image; determining one or more uncertainty regions associated with the depth map, wherein each uncertainty region identifies a different area of the input image having one or more pixels that can be in multiple depth layers on the input image; processing, using a second set of machine learning models, the depth map and the one or more uncertainty regions to determine, for each pixel in one of the one or more uncertainty regions, a foreground context and a background context for that pixel based on the depth map; and generating an output image based on the foreground context and background context for each pixel in the one or more uncertainty regions, wherein the output image forms a stereo pair with the input image.

CLAUSE 2. The computer-implemented method of clause 1, wherein generating the depth map comprises assigning pixel-wise depth values to pixels representing foreground and background objects depicted in the input image.

CLAUSE 3. The computer-implemented method of clause 1 or 2, wherein the one or more uncertainty regions are represented as a binary mask.

CLAUSE 4. The computer-implemented method of any of clauses 1-3, wherein the one or more uncertainty regions are represented as an integer value at each uncertain pixel location that indicates a number (N) of components that pixel needs to be unmixed.

CLAUSE 5. The computer-implemented method of any of clauses 1-4, wherein the second set of machine learning models generates, for a given uncertain pixel location, N alpha, color, and depth values at each pixel location based on a number of components into which the pixel needs to be unmixed.

CLAUSE 6. The computer-implemented method of any of clauses 1-5, wherein the second set of machine learning models generate at least one foreground value, background value, foreground depth, background depth, and opacity for each pixel location in the one or more uncertainty regions.

CLAUSE 7. The computer-implemented method of any of clauses 1-6, wherein generating the output image comprises performing one or more warping, inpainting, and compositing operations.

CLAUSE 8. In one or more embodiments, one or more non-transitory computer-readable media store instructions that, when executed by one or more processors, cause the one or more processors to perform the steps of: generating, using a first set of machine learning models, a depth map for an input image based on one or more depth values associated with pixels within the input image; determining one or more uncertainty regions associated with the depth map, wherein each uncertainty region identifies a different area of the input image having one or more pixels that can be in multiple depth layers on the input image; processing, using a second set of machine learning models, the depth map and the one or more uncertainty regions to determine, for each pixel in one of the one or more uncertainty regions, a foreground context and a background context for that pixel based on the depth map; and generating an output image based on the foreground context and background context for each pixel in the one or more uncertainty regions, wherein the output image forms a stereo pair with the input image.

CLAUSE 9. The one or more non-transitory computer-readable media of clause 8, wherein generating the predicted depth map comprises assigning pixel-wise depth values to pixels representing foreground and background objects depicted in the input image.

CLAUSE 10. The one or more non-transitory computer-readable media of clause 8 or 9, wherein the one or more uncertainty regions are represented as a binary mask.

CLAUSE 11. The one or more non-transitory computer-readable media of any of clauses 8-10, wherein the second set of machine learning models generates, for a given uncertain pixel location, N alpha, color, and depth values at each pixel location based on a number of components into which the pixel needs to be unmixed.

CLAUSE 12. The one or more non-transitory computer-readable media of any of clauses 8-11, wherein the second set of machine learning models generates, for a given uncertain pixel location, N alpha, color, and depth values at each pixel location based on the number of components that pixel needs to be unmixed.

CLAUSE 13. The one or more non-transitory computer-readable media of any of clauses 8-12, wherein the second set of machine learning models generate at least one foreground value, background value, foreground depth, background depth, and opacity for each pixel location in the one or more uncertainty regions.

CLAUSE 14. The one or more non-transitory computer-readable media of any of clauses 8-13, wherein generating the output image comprises performing one or more warping, inpainting, and compositing operations.

CLAUSE 15. In one or more embodiments, a system comprises: one or more memories storing instructions; and one or more processors that execute the instructions to: generate, using a first set of machine learning models, a depth map for an input image based on one or more depth values associated with pixels within the input image; determine one or more uncertainty regions associated with the depth map, wherein each uncertainty region identifies a different area of the input image having one or more pixels that can be in multiple depth layers on the input image; process, using a second set of machine learning models, the depth map and the one or more uncertainty regions to determine, for each pixel in one of the one or more uncertainty regions, a foreground context and a background context for that pixel based on the depth map; and generate an output image based on the foreground context and background context for each pixel in the one or more uncertainty regions, wherein the output image forms a stereo pair with the input image.

CLAUSE 16. The system of clause 15, wherein generating the predicted depth map comprises assigning pixel-wise depth values to pixels representing foreground and background objects depicted in the input image.

CLAUSE 17. The system of clause 15 or 16, wherein the one or more uncertainty regions are represented as a binary mask.

CLAUSE 18. The system of any of clauses 15-17, wherein the one or more uncertainty regions are represented as an integer value at each uncertain pixel location that indicates a number (N) of components that pixel needs to be unmixed.

CLAUSE 19. The system of any of clauses 15-18, wherein the second set of machine learning models generates, for a given uncertain pixel location, N alpha, color, and depth values at each pixel location based on a number of components into which the pixel needs to be unmixed.

CLAUSE 20. The system of any of clauses 15-19, wherein the second set of machine learning models generate at least one foreground value, background value, foreground depth, background depth, and opacity for each pixel location in the one or more uncertainty regions.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing stereo conversion, the computer-implemented method comprising:
generating, using a first set of machine learning models, a depth map for an input image based on one or more depth values associated with pixels within the input image;
determining one or more uncertainty regions associated with the depth map, wherein each uncertainty region identifies a different area of the input image having one or more pixels that can be in multiple depth layers on the input image;
processing, using a second set of machine learning models, the depth map and the one or more uncertainty regions to determine, for each pixel in one of the one or more uncertainty regions, a foreground context and a background context for that pixel based on the depth map; and
generating an output image based on the foreground context and background context for each pixel in the one or more uncertainty regions, wherein the output image forms a stereo pair with the input image.

2. The computer-implemented method of claim 1, wherein generating the depth map comprises assigning pixel-wise depth values to pixels representing foreground and background objects depicted in the input image.

3. The computer-implemented method of claim 1, wherein the one or more uncertainty regions are represented as a binary mask.

4. The computer-implemented method of claim 1, wherein the one or more uncertainty regions are represented as an integer value at each uncertain pixel location that indicates a number (N) of components that pixel needs to be unmixed.

5. The computer-implemented method of claim 4, wherein the second set of machine learning models generates, for a given uncertain pixel location, N alpha, color, and depth values at each pixel location based on a number of components into which the pixel needs to be unmixed.

6. The computer-implemented method of claim 1, wherein the second set of machine learning models generate at least one foreground value, background value, foreground depth, background depth, and opacity for each pixel location in the one or more uncertainty regions.

7. The computer-implemented method of claim 1, wherein generating the output image comprises performing one or more warping, inpainting, and compositing operations.

8. One or more non-transitory computer-readable media storing instructions that, when executed by one or more processors, cause the one or more processors to perform the steps of:
generating, using a first set of machine learning models, a depth map for an input image based on one or more depth values associated with pixels within the input image;
determining one or more uncertainty regions associated with the depth map, wherein each uncertainty region identifies a different area of the input image having one or more pixels that can be in multiple depth layers on the input image;
processing, using a second set of machine learning models, the depth map and the one or more uncertainty regions to determine, for each pixel in one of the one or more uncertainty regions, a foreground context and a background context for that pixel based on the depth map; and
generating an output image based on the foreground context and background context for each pixel in the one or more uncertainty regions, wherein the output image forms a stereo pair with the input image.

9. The one or more non-transitory computer-readable media of claim 8, wherein generating the predicted depth map comprises assigning pixel-wise depth values to pixels representing foreground and background objects depicted in the input image.

10. The one or more non-transitory computer-readable media of claim 8, wherein the one or more uncertainty regions are represented as a binary mask.

11. The one or more non-transitory computer-readable media of claim 8, wherein the second set of machine learning models generates, for a given uncertain pixel location, N alpha, color, and depth values at each pixel location based on a number of components into which the pixel needs to be unmixed.

12. The one or more non-transitory computer-readable media of claim 11, wherein the second set of machine learning models generates, for a given uncertain pixel location, N alpha, color, and depth values at each pixel location based on the number of components that pixel needs to be unmixed.

13. The one or more non-transitory computer-readable media of claim 8, wherein the second set of machine learning models generate at least one foreground value, background value, foreground depth, background depth, and opacity for each pixel location in the one or more uncertainty regions.

14. The one or more non-transitory computer-readable media of claim 8, wherein generating the output image comprises performing one or more warping, inpainting, and compositing operations.

15. A system, comprising:
one or more memories storing instructions; and
one or more processors that execute the instructions to:
generate, using a first set of machine learning models, a depth map for an input image based on one or more depth values associated with pixels within the input image;
determine one or more uncertainty regions associated with the depth map, wherein each uncertainty region identifies a different area of the input image having one or more pixels that can be in multiple depth layers on the input image;
process, using a second set of machine learning models, the depth map and the one or more uncertainty regions to determine, for each pixel in one of the one or more uncertainty regions, a foreground context and a background context for that pixel based on the depth map; and
generate an output image based on the foreground context and background context for each pixel in the one or more uncertainty regions, wherein the output image forms a stereo pair with the input image.

16. The system of claim 15, wherein generating the predicted depth map comprises assigning pixel-wise depth values to pixels representing foreground and background objects depicted in the input image.

17. The system of claim 15, wherein the one or more uncertainty regions are represented as a binary mask.

18. The system of claim 15, wherein the one or more uncertainty regions are represented as an integer value at each uncertain pixel location that indicates a number (N) of components that pixel needs to be unmixed.

19. The system of claim 18, wherein the second set of machine learning models generates, for a given uncertain pixel location, N alpha, color, and depth values at each pixel location based on a number of components into which the pixel needs to be unmixed.

20. The system of claim 15, wherein the second set of machine learning models generate at least one foreground value, background value, foreground depth, background depth, and opacity for each pixel location in the one or more uncertainty regions.
